(19) United States
(12) Patent Application Publication
(10) Pub. No.: US 2026/0037394 A1
(43) Pub. Date: Feb. 5, 2026

(54) DATABASE RECOVERY METHOD AND APPARATUS, STORAGE MEDIUM, AND ELECTRONIC DEVICE

(71) Applicant: TENCENT TECHNOLOGY (SHENZHEN) COMPANY LIMITED, Shenzhen (CN)

(72) Inventors: Shuo LI, Shenzhen (CN); Jingang LI, Shenzhen (CN); Xin WU, Shenzhen (CN); Lixiong ZHENG, Shenzhen (CN); Anqun PAN, Shenzhen (CN); Hailin LEI, Shenzhen (CN)

(21) Appl. No.: 19/359,421

(22) Filed: Oct. 15, 2025

Related U.S. Application Data
(63) Continuation of application No. PCT/CN2024/116223, filed on Sep. 2, 2024.

(30) Foreign Application Priority Data
Sep. 13, 2023 (CN) 202311178386.0

(51) Int. Cl. G06F 11/14

(52) U.S. Cl. CPC G06F 11/1469; G06F 2201/80

(57) ABSTRACT

A database recovery method performed by an electronic device includes obtaining object identifier sets corresponding to a plurality of applications, respectively. Each object identifier set includes object identifiers corresponding to a plurality of database objects called during operation of the application corresponding to the object identifier set. The method further includes determining respective key indexes of the plurality of applications that indicate importance of the applications, and determining a recovery order of database object subsets corresponding to the object identifier sets based on an order indicated by the key indexes. Each database object subset is determined based on the database objects corresponding to the object identifiers in the object identifier set corresponding to the database object subset. The method also includes sequentially performing data recovery on the database object subsets based on the recovery order.

### CROSS-REFERENCE TO RELATED APPLICATIONS

This application is a continuation of International Application No. PCT/CN2024/116223, filed on Sep. 2, 2024, which claims priority to Chinese Patent application No. 2023111783860, filed with the China National Intellectual Property Administration on Sep. 13, 2023 and entitled “DATABASE RECOVERY METHOD AND APPARATUS, STORAGE MEDIUM, AND ELECTRONIC DEVICE,” the entire contents of both of which are incorporated herein by reference.

### FIELD OF THE TECHNOLOGY

This application relates to the field of computer science, and specifically, to a database recovery technology.

### BACKGROUND OF THE DISCLOSURE

High availability of databases is of great significance to the operation of service applications, and fault recovery of databases is an important manifestation of the high availability. That is, when a database is abnormal, how to recover the database efficiently and quickly is very important to the operation of service applications.

Existing database recovery technologies all establish a database recovery point based on an entire database. Therefore, a plurality of applications using the same database can only be recovered simultaneously, resulting in excessively long recovery time for critical services. That is, the existing database recovery technologies have the problem of relatively low recovery efficiency.

### SUMMARY

In accordance with the disclosure, there is provided a database recovery method performed by an electronic device and including obtaining object identifier sets corresponding to a plurality of applications, respectively. Each object identifier set includes object identifiers corresponding to a plurality of database objects called during operation of the application corresponding to the object identifier set. The method further includes determining respective key indexes of the plurality of applications that indicate importance of the applications, and determining a recovery order of database object subsets corresponding to the object identifier sets based on an order indicated by the key indexes. Each database object subset is determined based on the database objects corresponding to the object identifiers in the object identifier set corresponding to the database object subset. The method also includes sequentially performing data recovery on the database object subsets based on the recovery order.

Also in accordance with the disclosure, there is provided an electronic device including a memory storing a computer program, and a processor configured to execute the computer program to obtain object identifier sets corresponding to a plurality of applications, respectively. Each object identifier set includes object identifiers corresponding to a plurality of database objects called during operation of the application corresponding to the object identifier set. The processor is further configured to execute the computer program to determine respective key indexes of the plurality of applications that indicate importance of the applications, and determine a recovery order of database object subsets corresponding to the object identifier sets based on an order indicated by the key indexes. Each database object subset is determined based on the database objects corresponding to the object identifiers in the object identifier set corresponding to the database object subset. The processor is also configured to execute the computer program to sequentially perform data recovery on the database object subsets based on the recovery order.

Also in accordance with the disclosure, there is provided a non-transitory computer-readable storage medium storing a computer program that, when executed by a processor, causes an electronic device including the processor to obtain object identifier sets corresponding to a plurality of applications, respectively. Each object identifier set includes object identifiers corresponding to a plurality of database objects called during operation of the application corresponding to the object identifier set. The computer program, when executed by the processor, further causes the electronic device to determine respective key indexes of the plurality of applications that indicate importance of the applications, and determine a recovery order of database object subsets corresponding to the object identifier sets based on an order indicated by the key indexes. Each database object subset is determined based on the database objects corresponding to the object identifiers in the object identifier set corresponding to the database object subset. The computer program, when executed by the processor, also causes the electronic device to sequentially perform data recovery on the database object subsets based on the recovery order.

### BRIEF DESCRIPTION OF THE DRAWINGS

The accompanying drawings described here are used to provide a further understanding of this application, and constitute a part of this application. Schematic embodiments of this application and descriptions thereof are used for interpreting this application, rather than constituting improper limitations of this application.

FIG. 1 is a schematic diagram showing a hardware environment of an exemplary database recovery method according to an embodiment of this application.

FIG. 2 is a flowchart of an exemplary database recovery method according to an embodiment of this application.

FIG. 3 is a schematic diagram showing an exemplary database recovery method according to an embodiment of this application.

FIG. 4 is a schematic diagram showing another exemplary database recovery method according to an embodiment of this application.

FIG. 5 is a schematic diagram showing still another exemplary database recovery method according to an embodiment of this application.

FIG. 6 is a schematic diagram showing still another exemplary database recovery method according to an embodiment of this application.

FIG. 7 is a schematic diagram showing still another exemplary database recovery method according to an embodiment of this application.

FIG. 8 is a schematic diagram showing still another exemplary database recovery method according to an embodiment of this application.

FIG. 9 is a schematic diagram showing still another exemplary database recovery method according to an embodiment of this application.

FIG. 10 is a schematic structural diagram of an exemplary database recovery apparatus according to an embodiment of this application.

FIG. 11 is a schematic structural diagram of an exemplary electronic device according to an embodiment of this application.

### DESCRIPTION OF EMBODIMENTS

To make a person skilled in the art better understand the technical solutions of this application, the technical solutions in the embodiments of this application will be clearly and completely described below with reference to the accompanying drawings in the embodiments of this application. Apparently, the described embodiments are merely some of the embodiments of this application, not all the embodiments. Based on the embodiments of this application, all other embodiments obtained by those of ordinary skill in the art without any creative efforts fall within the scope of protection of this application.

The terms “first,” “second,” and the like in the description and claims of this application and the above drawings are used for distinguishing similar objects, and do not need to be used for describing a specific order or sequence. Data used in this way may be interchanged in appropriate circumstances, so that the embodiments of this application described herein can be implemented in order other than those illustrated or described herein. In addition, the terms “include,” “have,” and any other variant thereof are intended to cover a non-exclusive inclusion. For example, a process, method, system, product, or device that includes a list of steps or units is not necessarily limited to those steps or units that are expressly listed, but may include other steps or units that are not expressly listed or are inherent to the process, method, system, product, or device.

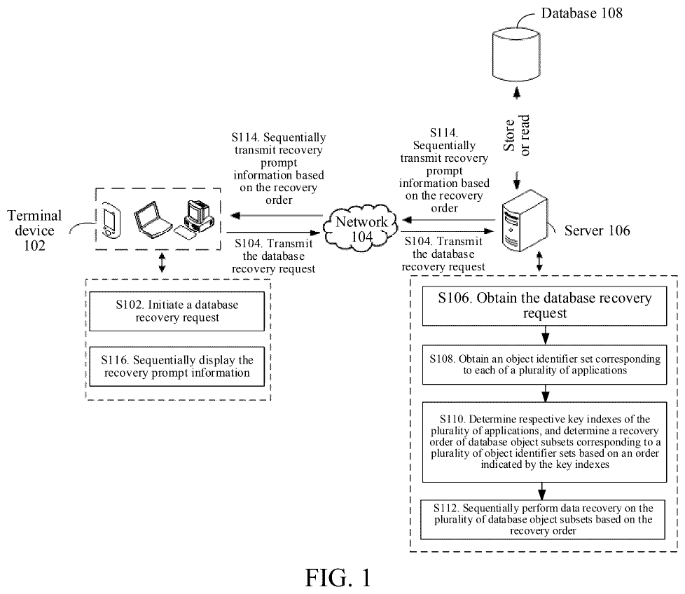

According to one aspect of the embodiments of this application, a database recovery method is provided. As an exemplary implementation, the database recovery method may, but is not limited to, be applied to a database recovery system in a hardware environment shown in FIG. 1. The database recovery system may include, but is not limited to, a terminal device 102, a network 104, a server 106, and a database 108. A target client runs in the terminal device 102 (as shown in FIG. 1, the target client is, for example, a client that can manage the database). The terminal device 102 includes a human-machine interaction screen, a processor, and a memory. The human-machine interaction screen is configured to display a database recovery operation interface and further to provide a human-machine interaction interface to receive an operation control instruction for indicating a database operation. The processor is configured to generate an interaction instruction in response to the human-computer interaction operation and transmit a data operation request corresponding to the interaction instruction to the server 106. The memory is configured to store processing results returned by the server 106.

In addition, the server 106 includes a processing engine, and the processing engine is configured to perform a storage or read operation on the database 108, including but not limited to a recovery operation on a database object. Specifically, the processing engine reads each to-be-recovered database object (also referred to as “target database object” or simply “target object”) from the database 108 and performs data recovery based on a recovery log.

Supposing that a client for initiating a database recovery request runs in the terminal device 102 in FIG. 1, a specific process of this embodiment is as follows: As in operation S102, the terminal device 102 initiates a database recovery request.

Then, as in operation S104, the terminal device 102 transmits the database recovery request to the server 106 via the network 104. The server 106 performs operations S106 to S112 to obtain the database recovery request, where the database recovery request is configured for requesting data recovery for database object sets corresponding to a plurality of applications; obtain object identifier sets corresponding to the plurality of applications, respectively, where each object identifier set includes object identifiers corresponding to a plurality of database objects called during operation of the application corresponding to the object identifier set; determine respective key indexes of the plurality of applications, and determine a recovery order of database object subsets corresponding to the plurality of object identifier sets, respectively, based on an order indicated by the key indexes, where a key index is configured for indicating the importance of the corresponding application, and a database object subset is determined based on the database objects corresponding to the object identifiers in the object identifier set corresponding to the database object subset; and sequentially perform data recovery on the plurality of database object subsets based on the recovery order.

Then, as in operation S114, each time the database object subset corresponding to one application is recovered, the server 106 may sequentially transmit recovery prompt information to the terminal device 102 based on the recovery order via the network 104. Finally, as in operation S116, the terminal device 102 sequentially displays the recovery prompt information, where the recovery prompt information is configured for indicating that the current application has completed the recovery of relevant database objects and is in a runnable state.

In this embodiment, the terminal device 102 may be configured with a target client and may include, but is not limited to, at least one of the following: a mobile phone (such as an Android phone or an iOS phone), a laptop, a tablet, a palmtop, MID (Mobile Internet Devices), a PAD, a desktop computer, a smart television, a smart speaker, a smart watch, and the like. The target client may be a video client, an instant messaging client, a browser client, an educational client, or the like that supports initiating a database recovery request. The network may include, but is not limited to, a wired network and a wireless network, where the wired network includes a local area network, a metropolitan area network, and a wide area network, while the wireless network includes Bluetooth, WIFI, and other networks that enable wireless communication. The server may be a single server, a server cluster composed of a plurality of servers, or a cloud server. The above is merely an example but not limitation.

The server 106 may be an independent physical server, or a server cluster or distributed system composed of a plurality of physical servers, or a cloud server that provides basic cloud computing services such as cloud services, cloud databases, cloud computing, cloud functions, cloud storage, network services, cloud communication, middleware services, domain name services, security services, content delivery networks (CDN), as well as big data and artificial intelligence platforms. The terminal 102 and the server 106 may be directly or indirectly connected through wired or wireless communication. This application does not provide limitations regarding this.

In the embodiments of this application, the database recovery request is obtained, where the database recovery request is configured for requesting data recovery for the database object sets corresponding to the plurality of applications; the object identifier sets corresponding to the plurality of applications, respectively, are obtained, where an object identifier set includes the object identifiers corresponding to the plurality of database objects called during operation of the application corresponding to the object identifier set; the respective key indexes of the plurality of applications are determined, and the recovery order of the database object subsets corresponding to the plurality of object identifier sets, respectively, is determined based on the order indicated by the key indexes, where a key index is configured for indicating the importance of the corresponding application, and a database object subset is determined based on the database objects corresponding to the object identifiers in the object identifier set corresponding to the database object subset; and data recovery is sequentially performed on the plurality of database object subsets based on the recovery order, thereby achieving hierarchical recovery of the plurality of database object subsets included in the database.

In the foregoing implementation of this application, when the database recovery request for the database object sets corresponding to the plurality of applications is obtained, the object identifier set corresponding to each application may be obtained first, then the recovery order of the database object subsets corresponding to the object identifier sets may be determined based on the key indexes of the applications, and different database object subsets in the object identifier sets are recovered based on the recovery order, whereby when the database object subset corresponding to one application is recovered, the application may recover operation first, thereby achieving sequential recovery of the plurality of applications, and solving the technical problem of relatively long time for application restart due to the fact that existing database recovery methods can merely recover data in an entire database. By hierarchical recovery of the database objects in this application, the plurality of applications recover operation sequentially, thereby solving the technical problem of low recovery efficiency of the existing database recovery methods.

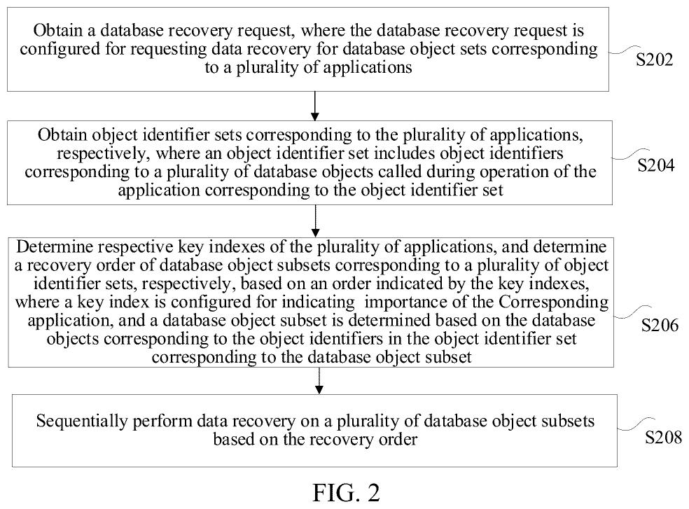

As an exemplary implementation, as shown in FIG. 2, the foregoing database recovery method includes the following operations:
S202: Obtain a database recovery request, where the database recovery request is configured for requesting data recovery for database object sets corresponding to a plurality of applications;
S204: Obtain object identifier sets corresponding to the plurality of applications, respectively, where an object identifier set includes object identifiers corresponding to a plurality of database objects called during operation of the application corresponding to the object identifier set;
S206: Determine respective key indexes of the plurality of applications, and determine a recovery order of database object subsets corresponding to the plurality of object identifier sets, respectively, based on an order indicated by the key indexes, where a key index is configured for indicating the importance of the corresponding application, and a database object subset is determined based on the database objects corresponding to the object identifiers in the object identifier set corresponding to the database object subset; and
S208: Sequentially perform data recovery on the plurality of database object subsets based on the recovery order.

The database recovery request in operation S202 may be automatically generated when an exception occurs in a database, or actively triggered by a user object. Specifically, the database recovery request may be configured for requesting recovery to a disk for relevant database objects from a time point when a fault occurs to a current time node, such as further loading a data operation that has been completed in a running memory of a server to a hard disk of the server, or revolving an unsubmitted data operation. In this implementation, the specific request content of the database recovery request is not limited.

Moreover, the database objects mentioned in the embodiments of this application may include, but are not limited to, operation objects corresponding to database-related processing operations, such as tables, indexes, views, charts, default values, rules, triggers, users, and functions. In this implementation, the specific types of the database objects are not limited.

In operation S202, the to-be-recovered database object set (also referred to as “target database object set” or simply “target object set”) is an object set composed of database objects corresponding to each of the plurality of applications. The plurality of applications may include, but are not limited to, an application set of a plurality of service applications, or a plurality of application functional modules included in the same application. For example, the plurality of applications may be configured for indicating application A, application B, application C, application D, and the like, or functional module a, functional module b, functional module c, and the like in application A. In this implementation, the specific types of the plurality of applications are not limited.

Further, in operation S204, the object identifier set corresponding to each of the plurality of applications may be obtained, and then the to-be-recovered database object subsets (also referred to as “target database object subsets” or simply “target object subsets”) corresponding to each application are determined. The object identifier set corresponding to one application may be determined based on the object identifiers of the database objects called during operation of the application, and the database object subset corresponding to one application may be determined based on the database objects corresponding to the object identifiers in the object identifier set corresponding to the application.

Then, in operation S206, the priority order of each application may be determined based on the key index of the application, and then the database object subsets corresponding to the application may be recovered in order. Therefore, hierarchical recovery of different parts in the database object set is achieved, and the applications corresponding to different database object subsets can recover operation sequentially based on the recovery order.

The key index may be configured for indicating the importance of each application during operation. For example, if application A is a basic application of application B, a higher key index is configured for application A to control prior recovery of the database object subset corresponding to application A. For another example, if a user object set involved in application A is greater than that involved in application B, corresponding key indexes may be configured for different applications based on scales of the user object sets. In this implementation, the configuration method of the key indexes is not limited.

In the foregoing implementation of this application, when the database recovery request for the database object sets corresponding to the plurality of applications is obtained, the object identifier set corresponding to each application may be obtained first, then the recovery order of the database object subset corresponding to each object identifier set may be determined based on the key index of each application, and different database object subsets in the object identifier sets are recovered based on the recovery order, whereby when the database object subset corresponding to one application is recovered, the application may recover operation first, thereby achieving sequential recovery of the plurality of applications, and solving the technical problem of relatively long time for application restart due to the fact that existing database recovery methods can merely recover data in an entire database. By hierarchical recovery of the database objects in this application, the plurality of applications recover operation sequentially, thereby solving the technical problem of low recovery efficiency of the existing database recovery methods.

In an exemplary implementation, the determining a recovery order of a database object subset corresponding to each of the plurality of object identifier sets based on an order indicated by the key indexes includes:
S1: Sequentially determine the database object subsets corresponding to the plurality of object identifier sets based on the order indicated by the key indexes; and
S2: Determine the order indicated by the key indexes as the recovery order of the plurality of database object subsets.

In this implementation, the database object subset corresponding to each object identifier set may be sequentially determined based on the order indicated by the key indexes, and then the database object subsets are sequentially recovered based on the order.

In an exemplary implementation, the database object subsets corresponding to one object identifier set may be determined as follows: for each object identifier included in the object identifier set, determining a unique database object corresponding to the object identifier; and then directly determining an object set composed of the database objects corresponding to the respective object identifiers in the object identifier set as the database object subset corresponding to the object identifier set.

In another exemplary implementation, the sequentially determining the database object subset corresponding to each of the plurality of object identifier sets based on the order indicated by the key indexes may include:
sequentially obtaining one object identifier set from the plurality of object identifier sets as a current identifier set based on the order indicated by the key indexes, and performing a database object subset determination operation on the current identifier set until the database object subset corresponding to each object identifier set is determined,
where the performing a database object subset determination operation includes the following operations:
S1: Determine the database object corresponding to each object identifier in the current identifier set as the database object in the database object subset corresponding to the current identifier set when the current identifier set does not include object identifiers in a historical identifier set; and
S2: Determine the database objects corresponding to the object identifiers in the current identifier set except the object identifiers in the historical identifier set as the database objects in the database object subset corresponding to the current identifier set when the current identifier set includes the object identifiers in the historical identifier set.

The historical identifier set is an object identifier set in the order indicated by the key indexes before the current identifier set.

In this implementation, each database object subset may be determined as follows: based on the order indicated by the key indexes, sequentially determining the database objects corresponding to the historically unprocessed object identifiers in each object identifier set, and utilizing these database objects to form the database object subset corresponding to the currently processed object identifier set.

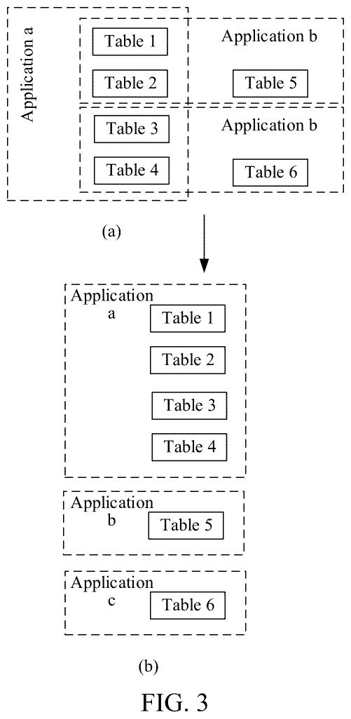

The following explains the above implementation in conjunction with FIG. 3. As shown in part (a) of FIG. 3, the object identifiers corresponding to application a are table 1, table 2, table 3, and table 4; the object identifiers corresponding to application b are table 1, table 2, and table 5; and the object identifiers corresponding to application c are table 6, table 3, and table 4.

As shown in part (b) of FIG. 3, when it is determined based on the order indicated by the key indexes that the priority of the three applications is application a>application b>application c, table objects corresponding to each of table 1, table 2, table 3, and table 4 in the object identifier set corresponding to application a may first be determined as a database object subset corresponding to the object identifier set of application a, that is, the database object subset corresponding to application a includes the table objects corresponding to each of table 1, table 2, table 3, and table 4;

Next, the database object subset corresponding to the object identifier set corresponding to application b is determined. Since the object identifier set corresponding to application b includes table 1, table 2, and table 5, and table 1 and table 2 have appeared in the object identifier set (historical identifier set) corresponding to application a, the table objects corresponding to table 5 that have not appeared may be determined to the database object subset corresponding to the object identifier set corresponding to application b, that is, the database object subset corresponding to application b includes the table objects corresponding to table 5;

Finally, the database object subset corresponding to the object identifier set corresponding to application c is determined. Since the object identifier set corresponding to application c includes table 6, table 3, and table 4, and table 3 and table 4 have appeared in the object identifier set (historical identifier set) corresponding to application a, the table objects corresponding to table 6 that have not appeared may be determined to the database object subset corresponding to the object identifier set corresponding to application c, that is, the database object subset corresponding to application c includes the table objects corresponding to table 6;

After the database object subsets corresponding to each of the plurality of object identifier sets are sequentially determined based on the order indicated by the key indexes, as shown in part (b) of FIG. 3, the order indicated by the key indexes is directly determined as the recovery order of the database object subsets, that is, the database object subset corresponding to application a, i.e., the table objects corresponding to each of table 1, table 2, table 3, and table 4, are recovered first; then, the database object subset corresponding to application b, i.e., the table objects corresponding to table 5, are recovered; and finally, the database object subset corresponding to application c, i.e., the table objects corresponding to table 6, are recovered.

Through the foregoing implementation of this application, the database object subsets corresponding to each application can be recovered in batches based on a priority relationship between the applications. Moreover, in the process of determining the recovery order of the database object subsets, a minimum database object subset required to recover the database corresponding to the current application may be further determined based on a relationship between the database objects included in the currently processed database object subset and the database object subset corresponding to the previously recovered or operated application, thereby improving the recovery efficiency of database objects.

In an exemplary implementation, the determining respective key indexes of the plurality of applications includes at least one of the following:

First method: Obtain a preset priority order corresponding to the plurality of applications, and determine the respective key indexes of the plurality of applications based on the preset priority order.

Second method: Obtain application dependencies of the plurality of applications during operation, and determine the respective key indexes of the plurality of applications based on the application dependencies.

Third method: Obtain a quantity of object identifiers included in the object identifier set corresponding to each of the plurality of applications, and determine the respective key indexes of the plurality of applications based on the quantity of identifiers. The quantity of object identifiers is also referred to as an “identifier quantity.”

It is understandable that, in this implementation, three exemplary methods for determining the foregoing key indexes are provided. In the first method, the key index may be determined based on the preset priority order corresponding to each of the plurality of applications. For example, the preset priority order may be an importance level defined by a user for each application. Based on this, higher key coefficients may be configured for the applications with higher importance levels, and then the recovery order of the database object subset corresponding to each application may be determined based on the user-defined importance level.

In the second method, the key index of each application may be determined based on the application dependency of each application during operation. For example, application a is a search application, and application b is a data processing application for further data processing based on search results, indicating that the operation of application b depends on the search results of application a. Further, based on the relationship that application b depends on application a, a higher key index may be configured for application a, thereby achieving prior recovery of the database objects corresponding to application A.

In the third method, the key index of each application may be determined based on the scale of the object identifier set corresponding to each application. For example, the object identifier set corresponding to application a includes 100 object identifiers, and the object identifier set corresponding to application b includes 10 object identifiers. Then, a higher key index is configured for application b to prioritize the recovery of application b.

In another exemplary implementation, the key index of each application may alternatively be determined based on the scale of the user object set corresponding to each application. For example, a monthly active user quantity of application a is 100,000, and a monthly active user quantity of application b is 10,000. Then, a higher key index is configured for application a to prioritize the recovery of related application services of application a.

It is understandable that the foregoing methods for determining key indexes may be combined in different manners. When the method for determining key indexes is a combination of the foregoing methods, a different index weight may be configured for each method, thereby determining the importance of each application more accurately.

Combinations of the foregoing methods are specifically described below.

In a first combination, the key index of each application may be determined by combining the first method and the second method. Specifically, the user-defined preset priority order and the dependency relationship between the applications analyzed from application functions may be obtained first, and then the key index of each application is determined based on the preset priority order and the dependency relationship. In some embodiments, when the user-defined preset priority order is default, the key index of each application may be directly determined based on the dependency relationship between the applications; or when the user-defined preset priority order is obtained, a first key coefficient may be assigned to each application based on the dependency relationship between the applications, a second key coefficient may be assigned to each application based on the preset priority order, and the key index of each application may be determined based on a weighted sum value of the first key coefficient and the second key coefficient.

For example, the user-defined priority order is: application A>application B>application C, and then the first key coefficients are assigned to applications A to C respectively: 100, 80, and 60. When it is determined by analysis on the dependency relationship between application functions that the function implementation of application C depends on application A and the function implementation of application B depends on both application A and application C, the second key coefficients may be assigned to applications A to C respectively: 100, 30, and 80. When the weights of the first key coefficients and the second key coefficients are the same, the key indexes of application A to application C are further determined as follows: 100*0.5+100*0.5=100, 80*0.5+30*0.5=55, and 60*0.5+80*0.5=70. That is, the key indexes of applications A to C are respectively: 100, 55, and 70. Then, application A is recovered first, followed by application C, and finally application B.

In a second combination, the key index of each application may be determined by combining the first method, the second method, and the third method. In this implementation, corresponding priorities may be configured for the methods respectively, and the key index of each application may be determined based on a priority relationship between the methods. For example, when the priority of the second method is the highest and the priorities of the first method and the third method are the same, and when the preset priority order specified by the user is contradictory to the priority relationship determined by application dependency analysis, the recovery order is preferably determined based on the priority relationship determined by application dependency analysis.

For example, when the priority order specified by the user is: application A>application B>application C>application D, and function dependencies obtained by dependency analysis on application functions are as follows: the function implementation of application C depends on application A, the function implementation of application B depends on both application A and application C, and the function implementation of application D depends on both application A and application C. The recovery order may be determined first based on the function dependencies as follows: application A>application C>application B=application D. That is, a highest key index is first configured for application A, then a second highest key index is configured for application C, respective key indexes of application B and application D are finally determined based on the weighted sum values of the key coefficients of application B and application D determined through the first method to the third method, and a recovery order of application B and application D is further determined.

In a third combination, the first key coefficient corresponding to each application may be first determined by the second method (i.e., function dependencies), and a recovery order may be determined based on the ranking of the first key coefficients. When the first key coefficients of different applications are the same, the recovery order of the applications with the same first key coefficient is determined based on the weighted sum values of the key coefficients determined through the first method, the third method, and the fourth method, respectively. Through the foregoing implementation of this application, any combination of the four exemplary methods achieves precise definition on the importance of the applications, and then the operations of application services corresponding to each application are sequentially and efficiently recovered based on the importance of each application.

In an exemplary implementation, the sequentially performing data recovery on a plurality of database object subsets based on the recovery order includes:
S1: Group M database object subsets based on a recovery task quantity corresponding to each of the M database object subsets to obtain N to-be-recovered object subsets, where M is an integer greater than or equal to 1, and N is an integer less than or equal to M and greater than or equal to 1;
S2: Obtain reference recovery information corresponding to each of the N to-be-recovered object subsets; and
S3: Determine a target order matching the recovery order based on the reference recovery information corresponding to each of the N to-be-recovered object subsets, and sequentially perform data recovery on the N to-be-recovered object subsets based on the target order.

In this implementation, after the plurality of database object subsets are determined, the database object subsets may be further grouped based on the data recovery task quantity corresponding to each database object subset to obtain the plurality of to-be-recovered object subsets, and data recovery is performed in units of the to-be-recovered object subsets.

It is understandable that, if data recovery is directly performed based on the database object subsets, more performance may be consumed to maintain the data recovery of each database object subset due to the large number of database object subsets. In the foregoing implementation of this application, the database object subsets may be further grouped based on the recovery task quantity of each database object subset, thereby reducing the quantity of database object recovery tasks and solving performance problems caused by excessive group division.

In an exemplary implementation, the grouping M database object subsets based on a recovery task quantity corresponding to each of the M database object subsets to obtain N to-be-recovered object subsets includes:
S1: Determine the recovery task quantity corresponding to each of the M database object subsets based on a quantity of recovery logs corresponding to each of the M database object subsets, where the recovery logs are configured for recording a database operation set generated after a target time point, and the target time point is a starting time point of a data recovery operation indicated in the data recovery request; and
S2: Group the M database object subsets based on the recovery task quantity to obtain the N to-be-recovered object subsets, where a difference in the quantity of recovery logs corresponding to any two to-be-recovered object subsets among the N to-be-recovered object subsets is less than or equal to a target threshold. The quantity of recovery logs is also referred to as a “log quantity.”

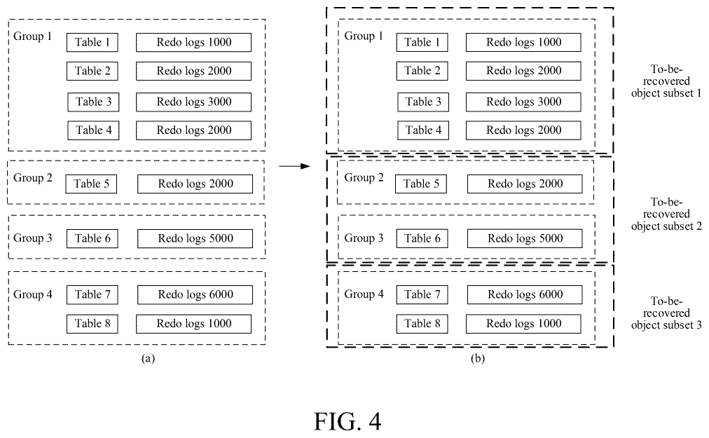

The following describes a specific process of the foregoing implementation in conjunction with FIG. 4.

In an exemplary implementation, the database object subsets may be merged based on the number of user-defined database recovery sets. In another exemplary implementation, when the user has not defined the number of database recovery sets, the number of database recovery sets may be reasonably determined based on current processing performance, to avoid the problem of explosion of database recovery information due to excessive recovery sets. The division of sets may be determined based on the number of redo logs (i.e., the recovery logs) of each checkpoint of the database objects within a period of time in the past.

The checkpoint refers to a time point when all modified data pages are written to a disk during system operation. When the database is faulty, the database can be quickly recovered to its latest stable state through relevant information recorded at the time point, thereby avoiding data loss or damage.

The redo logs may be configured for reconstructing all modifications made to the database (including recovery segments). The redo log is composed of a group of variation vectors, and each variation vector describes modifications made to a single block in the database. For example, if service volume values in a service data table are modified, a redo log including variation vectors is generated. These variation vectors describe modifications to data segment blocks of the table, undo segment data blocks, and undo segment transaction processing tables.

As shown in part (a) of FIG. 4, the following division is made based on recovered sets and incremental sets. Considering that excessive group division may lead to performance problems, the database object subsets may be merged based on the sizes of redo logs. Group division is performed in order, and to-be-recovered groups may be merged. As shown in part (a) of FIG. 4, the database object subsets corresponding to group 1 correspond to 8,000 redo logs; the database object subset corresponding to group 2 corresponds to 2,000 redo logs; the database object subset corresponding to group 3 corresponds to 5,000 redo logs; and the database object subsets corresponding to group 4 correspond to 7,000 redo logs. Then, the database object subsets may be re-grouped into to-be-recovered object subset 1, to-be-recovered object subset 2 (including group 2 and group 3), and to-be-recovered object subset 3, as shown in part (b) of FIG. 4, where each group corresponds to roughly equal redo logs, thereby reducing the overhead for maintaining the to-be-recovered object subsets.

In an exemplary implementation, the determining a target order matching the recovery order based on the reference recovery information corresponding to each of the N to-be-recovered object subsets, and sequentially performing data recovery on the N to-be-recovered object subsets based on the target order includes:
S1: Determine a data buffer corresponding to each of the N to-be-recovered object subsets, where the data buffers do not overlap with each other; and
S2: Sequentially perform data recovery on the N to-be-recovered object subsets based on the target order in the data buffer corresponding to each of the N to-be-recovered object subsets.

In the foregoing implementation of this application, data recovery may be performed in the data buffer corresponding to each to-be-recovered object subset.

Specifically, in order to implement database group recovery, recovery information needs to be stored respectively:
Firstly, the database objects are mapped to corresponding buffer pools based on the groups of the database objects;
Secondly, different buffer pools correspond to different to-be-recovered object subsets, and each to-be-recovered object subset includes an independent recovery information file and an independent redo log file.

After a to-be-recovered object subset is obtained, a corresponding relationship between the to-be-recovered object subset and the data buffer needs to be established, and the corresponding recovery information file and redo log are established for a different data buffer. Since the database recovery information is closely related to the data buffer, the relationship between the to-be-recovered object subset and the data buffer needs to be determined first, and then the relationship between the data buffer and the recovery file is confirmed. One to-be-recovered object subset may correspond to a plurality of data buffers, but the data buffers of each to-be-recovered object subset cannot overlap; and one to-be-recovered object subset can merely correspond to a group of recovery file and redo log.

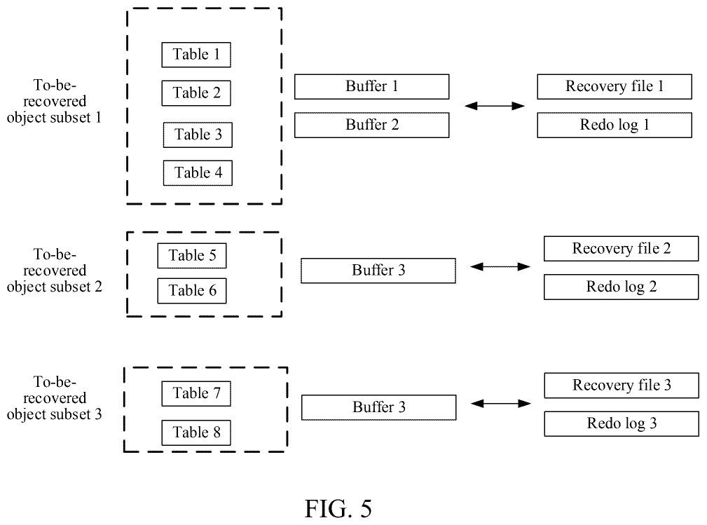

As shown in FIG. 5, the two data buffers corresponding to to-be-recovered object subset 1 are buffer 1 and buffer 2 respectively, and correspond to recovery file 1 and redo log 1. That is, in the process of recovering the database objects associated with to-be-recovered object subset 1, data recovery may be performed in buffer 1 and buffer 2 based on recovery file 1 and redo log 1. In addition, the data buffer corresponding to to-be-recovered object subset 2 is buffer 3, and corresponds to recovery file 2 and redo log 2; the data buffer corresponding to to-be-recovered object subset 3 is buffer 4, and corresponds to recovery file 3 and redo log 3.

In the recovery process, the following operations may be followed for hierarchical recovery.
S1: Sequentially read the recovery information based on the recovery order of the database;
S2: Perform database recovery based on the recovery information of each to-be-recovered object subset; and
S3: Output corresponding information each time the recovery of database objects in one to-be-recovered object subset is completed, to indicate that the corresponding application is available.

Through the foregoing implementation of this application, the corresponding relationship between the to-be-recovered object subset and the data buffer is established after the to-be-recovered object subset is obtained, and the corresponding recovery information files and redo logs are established for different data buffers, thereby ensuring the recovery of different to-be-recovered object subsets in different data buffers, avoiding errors in the recovery process, and improving the efficiency of database recovery.

In an exemplary implementation, the obtaining an object identifier set corresponding to each of the plurality of applications includes: obtaining one application from the plurality of applications as a current application, and performing an object identifier set determination operation on the current application until the plurality of applications are traversed,
where the performing an object identifier set determination operation includes the following operations:
S1: Determine a database operation statement from one or more running statements associated with the current application; and
S2: Determine a database object identifier included in the database operation statement as the object identifier in the object identifier set corresponding to the current application.

A method for obtaining an object identifier set corresponding to each application is specifically described below. Specifically, the method may include the following operations: parsing an application set by the user to obtain a statement related to the database; parsing the statement related to the database and determining corresponding database objects.

Generally, the database may be divided at the following levels:

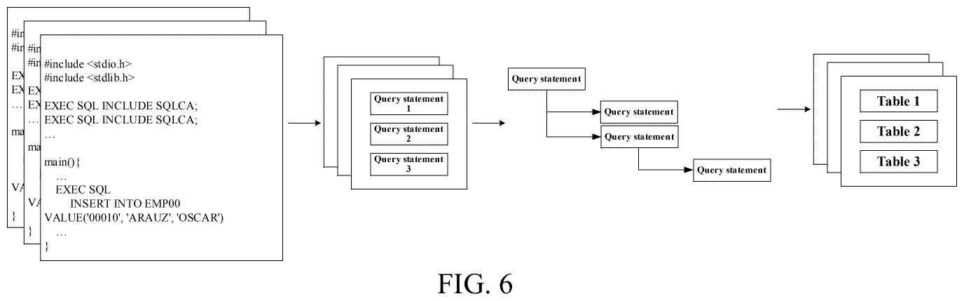

Firstly, the application specified by the user is parsed, and a corresponding relationship between the application and the database objects in the database is established based on parsing results. As shown in FIG. 6, database-related statements of an application may be parsed during compilation; a corresponding parsing tree of database statements is generated based on the database statements, and corresponding original data objects are obtained based on the parsing tree of database statements.

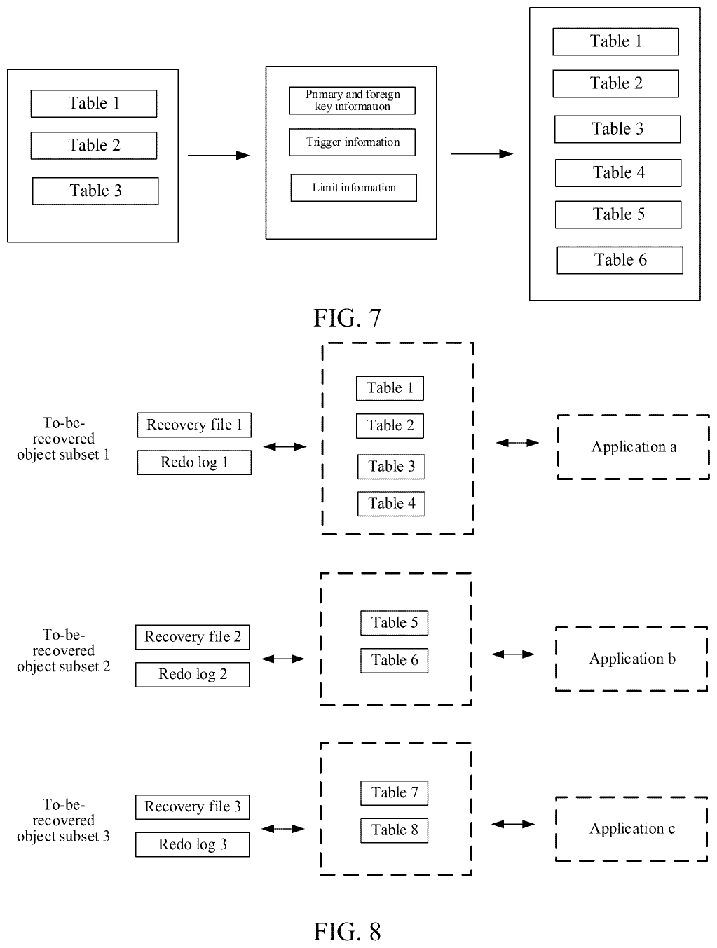

After a set of the original database objects is obtained, as shown in FIG. 7, all related database objects further need to be obtained based on primary and foreign key information, trigger information, limit information, and the like of the database.

Through the foregoing implementation of this application, the database operation statement may be determined from the one or more running statements associated with the running of the current application; the database object identifier included in the database operation statement is determined as the object identifier in the object identifier set corresponding to the current application, and then the object identifier set corresponding to the application may be determined based on the database object identifier included in the database-related operation statement called during operation of the application, thereby avoiding user's parsing on corresponding database objects occupied by each application, and improving the efficiency of parsing database objects.

In an exemplary implementation, after the sequentially performing data recovery on the plurality of database object subsets based on the recovery order, the method further includes: transmitting recovery prompt information when the database object subset associated with a target application among the plurality of applications completes data recovery, where the recovery prompt information is configured for indicating that the target application is currently in a runnable state.

As shown in FIG. 8, when each to-be-recovered object subset is recovered, a corresponding recovery file and redo log are obtained based on a defined recovery set to recover database objects. After the corresponding database objects are recovered, the user is notified that the corresponding application may be recovered for use. That is, after the database objects related to the application are recovered, the user is notified in a timely manner that the application is currently available.

One complete implementation process of this application is described below.

This implementation includes the following operations:
S1: Obtain user-defined importance levels of applications;
S2: Set a recovery order of the applications based on the importance levels of the applications; and
S3: Divide database objects into different recovery groups based on the recovery order.

A specific implementation process of operation S1 may further include: defining, by the user, the recovery order of different applications based on the importance levels of the applications, and completing the following operations on the database: parsing the application specified by the user to obtain involved database query statements; and analyzing the database objects involved in the obtained query statements.

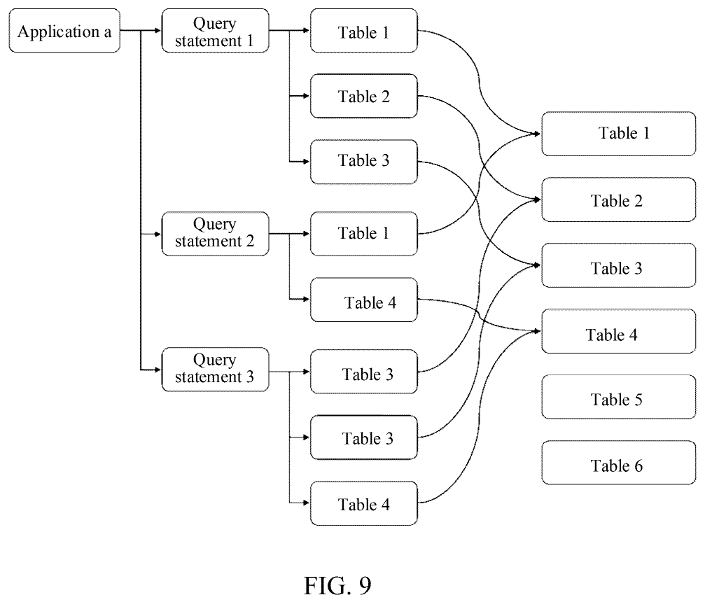

As shown in FIG. 9, application a includes 3 query statements, and each query statement corresponds to different database objects. The application is queried and parsed to obtain an information structure as shown in FIG. 9.

The user object defines application a, where the 3 query statements involved in application a are respectively query statement 1, query statement 2, and query statement 3. As shown in FIG. 9, the database objects involved in the three query statements include table 1, table 2, table 3, and table 4. Therefore, through the analysis of the above operations, if application a is to be recovered, merely the 4 involved tables need to be recovered. Then, application a can provide services externally.

Operation S2 may further include the following operations:
calculating a recovery order of database objects based on the analyzed corresponding relationship between the applications and the database objects and the user-specified importance order of the applications: based on the recovery order specified by the user, adding the database objects involved in the first application to a starting position of a recovery queue, indicating that these database objects are to be recovered first, thereby quickly recovering the most important applications; continuing to sequentially retrieve the database objects involved in the applications based on the importance of the applications, and adding the database objects that are not in the recovery queue to the recovery queue; and continuing in this way until all the database objects are in the recovery queue.

The following explains the above implementation in conjunction with FIG. 3. As shown in part (a) of FIG. 3, the object identifiers corresponding to application a include table 1, table 2, table 3, and table 4; the object identifiers corresponding to application b include table 1, table 2, and table 5; and the object identifiers corresponding to application c include table 6, table 3, and table 4.

If the importance order of applications defined by the user is application a, application b, and application c, application a is to be first recovered, and correspondingly, table 1, table 2, table 3, and table 4 are first added to a recovery queue. Next, application b is to be recovered, and table 5 is added to the recovery queue. Finally, table 6 corresponding application c is added to the recovery queue. Therefore, a recovery order as shown in part (b) of FIG. 3 can be obtained.

Operation S3 may further include: dividing the database objects into different recovery groups based on the recovery order of the database objects: first, establishing a plurality of to-be-recovered object subsets based on an initially recovered database object subset and each increased database object subset; and merging the to-be-recovered object subsets based on a user-defined number of to-be-recovered object subsets, to avoid the problem of explosion of database recovery information due to excessive recovery sets. The division of the to-be-recovered object subsets is based on the number of redo logs of each checkpoint of the database objects within a period of time in the past.

As shown in part (a) of FIG. 4, the following division is made based on recovered sets and incremental sets. Considering that excessive division may lead to performance problems, merging may be performed based on the sizes of redo logs. Group division is performed in order, and database object subsets may be merged. As shown in part (a) of FIG. 4, the database object subsets corresponding to group 1 correspond to 8,000 redo logs; the database object subset corresponding to group 2 corresponds to 2,000 redo logs; the database object subset corresponding to group 3 corresponds to 5,000 redo logs; and the database object subsets corresponding to group 4 correspond to 7,000 redo logs. Then, the database object subsets may be re-grouped into to-be-recovered object subset 1, to-be-recovered object subset 2 (including group 2 and group 3), and to-be-recovered object subset 3, where each to-be-recovered object subset corresponds to roughly equal redo logs, thereby reducing the overhead for maintaining to-be-recovered groups.

Finally, in the process of sequentially recovering the to-be-recovered object subsets, as shown in FIG. 8, first, recovery information is sequentially read based on the recovery order of the database; the database objects are recovered based on the recovery information of each to-be-recovered object subset; and each time the recovery of database objects of one to-be-recovered object subset is completed, corresponding information is output, indicating that the corresponding application is available.

In the foregoing implementation of this application, when the database recovery request for the database object sets corresponding to the plurality of applications is obtained, the object identifier set corresponding to each application may be obtained first, then the recovery order of the database object subset corresponding to each object identifier set may be determined based on the key index of each application, and different database object subsets in the object identifier sets are recovered based on the recovery order, whereby when the database object subset corresponding to one application is recovered, the application may recover operation first, thereby achieving sequential recovery of the plurality of applications, and solving the technical problem of relatively long time for application restart due to the fact that existing database recovery methods can merely recover data in an entire database. By hierarchical recovery of the database objects in this application, the plurality of applications recover operation sequentially, thereby solving the technical problem of low recovery efficiency of the existing database recovery methods.

In the foregoing implementation of this application, the database objects are automatically stratified to establish the plurality of database object subsets, and a different database recovery point is established for each database object subset; and when the database is recovered, the recovery of high-importance database object subsets is prioritized to achieve a purpose of quickly recovering critical applications.

For the sake of simplicity, the foregoing method embodiments are all expressed as a series of operation combinations. However, a person skilled in the art is aware that this application is not limited by the sequence of the described operations, because according to this application, some operations may be carried out in other sequences or simultaneously. In addition, a person skilled in the art learns that all the embodiments described in the specification are preferred embodiments, and the involved operations and modules are not necessarily mandatory to this application.

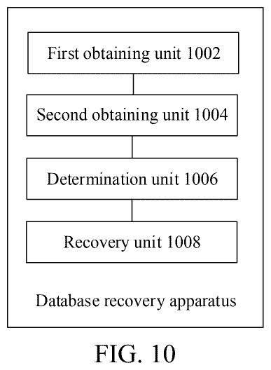

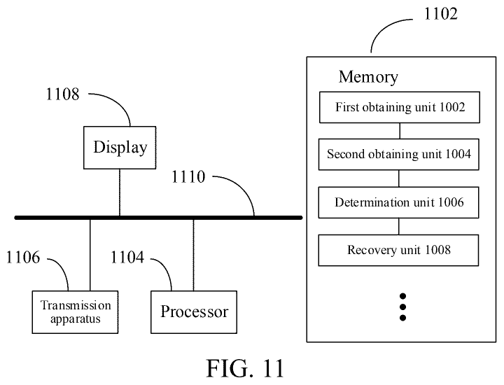

According to another aspect of the embodiments of this application, a database recovery apparatus for implementing the foregoing database recovery method is further provided. As shown in FIG. 10, the apparatus includes:
a first obtaining unit 1002, configured to obtain a database recovery request, where the database recovery request is configured for requesting data recovery for database object sets corresponding to a plurality of applications;
a second obtaining unit 1004, configured to obtain an object identifier set corresponding to each of the plurality of applications, where the object identifier set includes object identifiers corresponding to a plurality of database objects called during operation of the application corresponding to the object identifier set;
a determination unit 1006, configured to determine respective key indexes of the plurality of applications, and determine a recovery order of a database object subset corresponding to each of the plurality of object identifier sets based on an order indicated by the key indexes, where the key indexes are configured for indicating the importance of the applications, and the database object subset is determined based on the database objects corresponding to the object identifiers in the object identifier set corresponding to the database object subset; and
a recovery unit 1008, configured to sequentially perform data recovery on the plurality of database object subsets based on the recovery order.

In some embodiments, the determination unit 1006 includes:
a first determination module, configured to sequentially determine the database object subset corresponding to each of the plurality of object identifier sets based on the order indicated by the key indexes; and
a second determination module, configured to determine the order indicated by the key indexes as the recovery order of the plurality of database object subsets.

In some embodiments, the first determination module is configured to:
sequentially obtain one object identifier set from the plurality of object identifier sets as a current identifier set based on the order indicated by the key indexes, and perform a database object subset determination operation on the current identifier set until the plurality of database object subsets corresponding to each object identifier set are determined:
where the performing a database object subset determination operation includes:
determining the database object corresponding to each object identifier in the current identifier set as the database object in the database object subset corresponding to the current identifier set when the current identifier set does not include object identifiers in a historical identifier set; or determining the database objects corresponding to the object identifiers in the current identifier set except the object identifiers in the historical identifier set as the database objects in the database object subset corresponding to the current identifier set when the current identifier set includes the object identifiers in the historical identifier set; where the historical identifier set is an object identifier set in the order indicated by the key indexes before the current identifier set.

In some embodiments, the determination unit 1006 is further configured to perform at least one of the following:
obtain a preset priority order corresponding to the plurality of applications, and determine the respective key indexes of the plurality of applications based on the preset priority order;
obtain application dependencies of the plurality of applications during operation, and determine the respective key indexes of the plurality of applications based on the application dependencies; and
obtain a quantity of object identifiers included in the object identifier set corresponding to each of the plurality of applications, and determine the respective key indexes of the plurality of applications based on the quantity of identifiers.

In some embodiments, the recovery unit 1008 is configured to:
group M database object subsets based on a recovery task quantity corresponding to each of the M database object subsets to obtain N to-be-recovered object subsets, where M is an integer greater than or equal to 1, and Nis an integer less than or equal to M and greater than or equal to 1; obtain reference recovery information corresponding to each of the N to-be-recovered object subsets; and determine a target order matching the recovery order based on the reference recovery information corresponding to each of the N to-be-recovered object subsets, and sequentially perform data recovery on the N to-be-recovered object subsets based on the target order.

In some embodiments, the recovery unit 1008 is configured to:
determine a data buffer corresponding to each of the N to-be-recovered object subsets, where the data buffers do not overlap with each other; and sequentially perform data recovery on the N to-be-recovered object subsets based on the target order in the data buffer corresponding to each of the N to-be-recovered object subsets.

In some embodiments, the recovery unit 1008 is configured to: determine the recovery task quantity corresponding to each of the M database object subsets based on a quantity of recovery logs corresponding to each of the M database object subsets, where the recovery logs are configured for recording a database operation set generated after a target time point, and the target time point is a starting time point of a data recovery operation indicated in the data recovery request; and group the M database object subsets based on the recovery task quantity to obtain the N to-be-recovered object subsets, where a difference in the quantity of recovery logs corresponding to any two to-be-recovered object subsets among the N to-be-recovered object subsets is less than or equal to a target threshold.

In some embodiments, the second obtaining unit is configured to:
obtain one application from the plurality of applications as a current application, and perform an object identifier set determination operation on the current application until the plurality of applications are traversed,
where the performing an object identifier set determination operation includes:
determining a database operation statement from one or more running statements associated with the current application; and determining a database object identifier included in the database operation statement as the object identifier in the object identifier set corresponding to the current application.

In some embodiments, the foregoing database recovery apparatus is further configured to: transmit recovery prompt information when the database object subset associated with a target application among the plurality of applications completes data recovery, where the recovery prompt information is configured for indicating that the target application is currently in a runnable state.

In this embodiment, the embodiment to be implemented by each of the units and modules may refer to each of the foregoing method embodiments, and will not be elaborated here.

According to another aspect of the embodiments of this application, an electronic device for implementing the foregoing database recovery method is further provided. The electronic device may be the terminal device or server shown in FIG. 1. In this embodiment, the electronic device is the terminal device as an example for description. As shown in FIG. 11, the electronic device includes a memory 1102 and a processor 1104, the memory 1102 having a computer program stored therein, and the processor 1104 being configured to perform the operations in any of the foregoing method embodiments through the computer program.

In this embodiment, the electronic device may be at least one network device among a plurality of network devices in a computer network.

In this embodiment, the processor may be configured to perform the foregoing database recovery method through a computer program.

In some embodiments, it may be understood by a person of ordinary skill in the art that the structure shown in FIG. 11 is merely illustrative. The electronic device may alternatively be a smart phone (such as an Android phone or an iOS phone), a tablet, a palmtop, mobile Internet devices (MID), a PAD, or the like. FIG. 11 does not limit the structure of the electronic device. For example, the electronic device may include more or fewer components (such as network interfaces) than those shown in FIG. 11, or have configurations different from those shown in FIG. 11.

The memory 1102 may be configured to store software programs and modules, such as program instructions/modules corresponding to the database recovery method and apparatus in the embodiments of this application. The processor 1104 executes various functional applications and data processing by running the software programs and modules stored in the memory 1102, namely, implements the foregoing database recovery method. The memory 1102 may include a high-speed random access memory, and may alternatively include a non-volatile memory, such as one or more magnetic storage apparatuses, flash memories, or other non-volatile solid-state memories. In some examples, the memory 1102 may further include memories remotely disposed relative to the processor 1104, and these remote memories may be connected to the terminal through a network. Examples of the network include, but are not limited to, the Internet, an intranet, a local area network, a mobile communications network, or a combination thereof. The memory 1102 may specifically, but is not limited to, be configured to store various elements in a scenario image, database recovery information, and the like. As an example, as shown in FIG. 11, the memory 1102 may include, but is not limited to, the first obtaining unit 1002, the second obtaining unit 1004, the determination unit 1006, and the recovery unit 1008 in the foregoing database recovery apparatus. In addition, the memory may further include, but is not limited to, other modules and units in the foregoing database recovery apparatus. Details will not be described in this example.

In some embodiments, the transmission apparatus 1106 is configured to receive or transmit data via a network. Specific examples of the network may include wired networks and wireless networks. In one example, the transmission apparatus 1106 includes a network interface controller (NIC) connected to other network devices and routers via network cables to communicate with the Internet or local area network. In one example, the transmission apparatus 1106 is a radio frequency (RF) module, configured to communicate with the Internet in a wireless manner.

Moreover, the electronic device further includes: a display 1108, configured to display a virtual scenario in an interface; and a connection bus 1110, configured to connect various modules and components in the electronic device.

In other embodiments, the foregoing terminal device or server may be a node in a distributed system, where the distributed system may be a blockchain system, and the blockchain system may be the distributed system formed by connecting a plurality of nodes in a form of network communication. The nodes may form a peer to peer network. Any form of computing device, such as a server, a terminal, and other electronic devices, may become a node in the blockchain system by joining the peer to peer network.

According to one aspect of this application, a computer program product is provided, the computer program product including a computer program/instruction, and the computer program/instruction including program code for performing the methods shown in the flowcharts. In such an embodiment, the computer program may be downloaded from a network via a communication portion and installed, and/or installed from a removable medium. When the computer program is executed by a central processing unit, various functions provided by the embodiments of this application are performed.

The serial numbers of the foregoing embodiments of this application are merely for description, and do not imply the preference of the embodiments.

According to one aspect of this application, a computer-readable storage medium is provided, a processor of a computer device reading computer instructions from the computer-readable storage medium, and the processor executing the computer instructions, enabling the computer device to perform the foregoing database recovery method.

In this embodiment, the computer-readable storage medium may be stored to perform the foregoing database recovery method.

In this embodiment, a person of ordinary skill in the art may understand that all or part of the operations in the methods of the foregoing embodiments may be completed by a program instructing hardware related to a terminal device. The program may be stored in the computer-readable storage medium, and the storage medium may include: a flash drive, a read-only memory (ROM), a random access memory (RAM), a magnetic disk, an optical disk, or the like.

When the integrated unit in the foregoing embodiments is implemented in a form of a software function unit and is sold or used as an independent product, the integrated unit may be stored in the computer-readable storage medium. Based on such an understanding, the technical solutions of this application essentially or the part that contributes to the related art or all or part of the technical solutions may be embodied in a form of a software product. The software product is stored in a storage medium, and includes a plurality of instructions enabling one or more computer devices (such as a personal computer, a server, or a network device) to perform all or part of the operations of the foregoing method in each embodiment of this application.

In the foregoing embodiments of this application, the description of each embodiment has different emphasis. For a part that is not described in detail in an embodiment, reference may be made to relevant descriptions of other embodiments.

In the several embodiments provided in this application, the disclosed client may be implemented in other manners. The apparatus embodiments described above are merely illustrative. For example, the division of the foregoing units is merely a logical functional division. During actual implementation, there may be alternative division methods, for example, a plurality of units or components may be combined or integrated into another system, or some features may be ignored or not executed. In addition, the displayed or discussed mutual coupling or direct coupling or communication connection may be implemented through some interfaces. The indirect coupling or communication connection between units or modules may be in an electrical form or other forms.

The units described as separate components above may be or may not be physically separated. The components displayed as units may be or may not be physical units, that is, located in one place or distributed across a plurality of network units. Part or all of the units may be selected based on actual requirements to achieve the objectives of the solutions of the embodiments.

In addition, the functional units in the embodiments of this application may be integrated into one processing unit, or each of the units may exist alone physically, or two or more units may be integrated into one unit. The integrated unit may be implemented in a form of hardware or a software functional unit.

Described above are merely some embodiments of this application. For a person of ordinary skill in the technical field, improvements and modifications may be made without departing from the principles of this application, and these improvements and modifications fall within the scope of this application.

What is claimed is:

1. A database recovery method, performed by an electronic device, comprising:
obtaining object identifier sets corresponding to a plurality of applications, respectively, each object identifier set including object identifiers corresponding to a plurality of database objects called during operation of the application corresponding to the object identifier set;
determining respective key indexes of the plurality of applications, the key indexes indicating importance of the applications;
determining a recovery order of database object subsets corresponding to the object identifier sets based on an order indicated by the key indexes, each database object subset being determined based on the database objects corresponding to the object identifiers in the object identifier set corresponding to the database object subset; and
sequentially performing data recovery on the database object subsets based on the recovery order.

2. The method according to claim 1, wherein determining the recovery order includes:
sequentially determining the database object subsets corresponding to the object identifier sets based on the order indicated by the key indexes; and
determining the order indicated by the key indexes as the recovery order.

3. The method according to claim 2, wherein sequentially determining the database object subset includes sequentially performing the following based on the order indicated by the key indexes until the database object subsets corresponding to all of the object identifier sets are determined:
obtaining one object identifier set from the object identifier sets as a current identifier set; and
performing a database object subset determination operation on the current identifier set.

4. The method according to claim 3, wherein:
performing the database object subset determination operation on the current identifier set includes:
determining, in response to the current identifier set not including object identifiers in a historical identifier set, the database object corresponding to each object identifier in the current identifier set as the database object in the database object subset corresponding to the current identifier set; or
determining, in response to the current identifier set including one or more historical object identifiers in the historical identifier set, the database objects corresponding to the object identifiers in the current identifier set except the one or more historical object identifiers as the database objects in the database object subset corresponding to the current identifier set; and
the historical identifier set is an object identifier set before the current identifier set according to the order indicated by the key indexes.

5. The method according to claim 1, wherein determining the respective key indexes of the plurality of applications includes:
obtaining a preset priority order corresponding to the plurality of applications; and
determining the respective key indexes of the plurality of applications based on the preset priority order.

6. The method according to claim 1, wherein determining the respective key indexes of the plurality of applications includes:
obtaining application dependencies of the plurality of applications during operation, and
determining the respective key indexes of the plurality of applications based on the application dependencies.

7. The method according to claim 1, wherein determining the respective key indexes of the plurality of applications includes:
obtaining a plurality of identifier quantities each being a quantity of object identifiers in the object identifier set corresponding to one of the plurality of applications; and
determining the respective key indexes of the plurality of applications based on the plurality of identifier quantities.

8. The method according to claim 1, wherein sequentially performing data recovery on the database object subsets includes:
grouping M database object subsets based on recovery task quantities corresponding to the M database object subsets, respectively, to obtain N target object subsets to be recovered, M being an integer greater than or equal to 1, and N being an integer less than or equal to M and greater than or equal to 1;
obtaining reference recovery information corresponding to the N target object subsets; and
determining a target order matching the recovery order based on the reference recovery information corresponding to the N target object subsets, and sequentially performing data recovery on the N target object subsets based on the target order.

9. The method according to claim 8, wherein determining the target order and sequentially performing data recovery on the N target object subsets based on the target order includes:
determining data buffers corresponding to the N target object subsets, respectively, the data buffers not overlapping with each other; and
sequentially performing data recovery on the N target object subsets based on the target order in the data buffers corresponding to the N target object subsets, respectively.

10. The method according to claim 8, wherein grouping the M database object subsets includes:
determining the recovery task quantities corresponding to the M database object subsets based on log quantities each being a quantity of recovery logs corresponding to one of the M database object subsets, the recovery logs recording a database operation set generated after a starting time point of a data recovery operation indicated in a data recovery request; and
grouping the M database object subsets based on the recovery task quantities to obtain the N target object subsets, a difference in the log quantities corresponding to any two of the N target object subsets being less than or equal to a target threshold.

11. The method according to claim 1, wherein obtaining the object identifier sets includes performing the following until all of the plurality of applications are traversed:
obtaining one of the plurality of applications as a current application; and
performing an object identifier set determination operation on the current application.

12. The method according to claim 11, wherein performing the object identifier set determination operation includes:
determining a database operation statement from one or more running statements associated with the current application; and
determining a database object identifier included in the database operation statement as the object identifier in the object identifier set corresponding to the current application.

13. The method according to claim 1, further comprising, after sequentially performing data recovery on the database object subsets:
transmitting recovery prompt information in response to the database object subset associated with a target application among the plurality of applications completing data recovery, the recovery prompt information indicating that the target application is currently in a runnable state.

14. An electronic device comprising:
a memory storing a computer program; and
a processor configured to execute the computer program to:
obtain object identifier sets corresponding to a plurality of applications, respectively, each object identifier set including object identifiers corresponding to a plurality of database objects called during operation of the application corresponding to the object identifier set;
determine respective key indexes of the plurality of applications, the key indexes indicating importance of the applications;
determine a recovery order of database object subsets corresponding to the object identifier sets based on an order indicated by the key indexes, each database object subset being determined based on the database objects corresponding to the object identifiers in the object identifier set corresponding to the database object subset; and
sequentially perform data recovery on the database object subsets based on the recovery order.

15. The electronic device according to claim 14, wherein the processor is further configured to execute the computer program to, when determining the recovery order:
sequentially determine the database object subsets corresponding to the object identifier sets based on the order indicated by the key indexes; and
determine the order indicated by the key indexes as the recovery order.

16. The electronic device according to claim 15, wherein the processor is further configured to execute the computer program to, when sequentially determining the database object subset, sequentially perform the following based on the order indicated by the key indexes until the database object subsets corresponding to all of the object identifier sets are determined:
obtaining one object identifier set from the object identifier sets as a current identifier set; and
performing a database object subset determination operation on the current identifier set.

17. The electronic device according to claim 16 wherein:
the processor is further configured to execute the computer program to, when performing the database object subset determination operation on the current identifier set:
determine, in response to the current identifier set not including object identifiers in a historical identifier set, the database object corresponding to each object identifier in the current identifier set as the database object in the database object subset corresponding to the current identifier set; or
determine, in response to the current identifier set including one or more historical object identifiers in the historical identifier set, the database objects corresponding to the object identifiers in the current identifier set except the one or more historical object identifiers as the database objects in the database object subset corresponding to the current identifier set; and
the historical identifier set is an object identifier set before the current identifier set according to the order indicated by the key indexes.

18. The electronic device according to claim 14, wherein the processor is further configured to execute the computer program to, when determining the respective key indexes of the plurality of applications:
obtain a preset priority order corresponding to the plurality of applications; and
determine the respective key indexes of the plurality of applications based on the preset priority order.

19. The electronic device according to claim 14, wherein the processor is further configured to execute the computer program to, when determining the respective key indexes of the plurality of applications:
obtain application dependencies of the plurality of applications during operation, and
determine the respective key indexes of the plurality of applications based on the application dependencies.

20. A non-transitory computer-readable storage medium storing a computer program that, when executed by a processor, causes an electronic device including the processor to:
obtain object identifier sets corresponding to a plurality of applications, respectively, each object identifier set including object identifiers corresponding to a plurality of database objects called during operation of the application corresponding to the object identifier set;
determine respective key indexes of the plurality of applications, the key indexes indicating importance of the applications;
determine a recovery order of database object subsets corresponding to the object identifier sets based on an order indicated by the key indexes, each database object subset being determined based on the database objects corresponding to the object identifiers in the object identifier set corresponding to the database object subset; and
sequentially perform data recovery on the database object subsets based on the recovery order.
